(19) United States
(12) Patent Application Publication
(10) Pub. No.: US 2006/0248894 A1
(43) Pub. Date: Nov. 9, 2006

(54) Fuel gas calorie control equipment and gas turbine system

(75) Inventors: Koji Hiramoto, Takasago (JP); Takuya Murase, Takasago (JP); Tomoshige Takata, Takasago (JP); Hiroshi Kawane, Takasago (JP); Takashi Sonoda, Takasago (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 11/349,118

(22) Filed: Feb. 8, 2006

(30) Foreign Application Priority Data
Feb. 28, 2005 (JP) 2005-052356

(51) Int. Cl. F02C 1/00

(52) U.S. Cl. 60/772

(57) ABSTRACT

When CFG's are supplied to a gas tank 2, the fluctuation ratio of the gas calories of the CFG's is restrained by supplying the CFG's different time delays and mixing them. When the CFG's are mixed with BFG in a gas mixer 3, the gas flow rate of the BFG is controlled by feedback control based on the gas calories of a mixed gas, thereby controlling the gas calories of the mixed gas to be specific.

The present invention is based on the Japanese Patent Application No. 2005-52356 applied on Feb. 28, 2005.

### BACKGROUND OF THE INVENTION

1. Field of the Invention

The present invention relates to a fuel gas calorie control equipment which controls gas calories of a fuel gas in a combustion system having a blast furnace gas serve as a fuel gas to be specific, and also relates to a gas turbine system which is supplied with a fuel gas having the gas calories thereof controlled to be specific by the fuel gas calorie control equipment in accordance with the present invention.

2. Description of the Prior Art

At present, a blast furnace gas being a byproduct gas which is discharged from a blast furnace at a steel mill contains a large amount of carbon monoxide (CO), and a gas turbine power generation system has been developed, using the blast furnace gas as a main fuel. In such a gas turbine power generation system, the gas calories of a blast furnace gas being generated fluctuate greatly, depending on operational condition of the blast furnace. In consequence, due to the fluctuations of the gas calories of the blast furnace gas, an output of power generation of a gas turbine using the blast furnace gas as a main fuel undergoes a change. Especially, when the gas calories of the blast furnace gas fluctuate largely, there occurs a case resulting in an unstable combustion or an accidental fire.

Therefore, in order to stabilize the operation of a gas turbine power generation system, such a method is used as measuring the gas calories of a fuel gas being supplied to the gas turbine power generation system and making a feedback adjustment of the amount of gas to be ignited so as to control the gas calories to be specific, or such a method is used as adjusting the amount of gas to be ignited so as to control the output of power generation of a gas turbine to be specific. Additionally, as a combustion control method to control the gas calories of a mixed gas having the blast furnace gas (BFG) and cokes oven gas (COG) mixed to be specific, a combustion control method for controlling the gas calories to be specific is suggested for a cokes oven, which estimates a COG flow rate when fluctuations thereof are stabilized in a mixed flow gas rate control system controlling the flow rate of a mixed gas to be specific and controls the gas calories of the mixed gas to be specific by using the estimated COG flow rate. (See the Japanese Patent Application Laid-Open No. H7-19453.)

Additionally, the applicant of the present invention also suggests a fuel gas calorie control equipment for controlling the gas calories of a fuel gas being supplied from a gas mixer in a gas turbine system which is provided with a gas mixer mixing BFG and COG and is put into operation by using a fuel gas being mixed in the gas mixer. (See the Japanese Patent Application Laid-Open 2004-190632.)

The fuel gas calorie control equipment being described hereinabove is provided with a gas calorimeter which measures the gas calories of a fuel gas being supplied to a gas turbine. Then, based on the measurement results of the gas calorimeter, the gas calories of a fuel gas being mixed in a gas mixer are estimated, so as to perform feedback control which controls the gas calorie of a fuel gas being supplied to the gas turbine to be specific. Additionally, a gas calorimeter is installed to measure the gas calories of BFG being supplied to the gas mixer. Then, based on the measurement results of the gas calorimeter, fluctuations of the gas calories of BFG are detected beforehand, thereby performing feedforward control that restrains adverse effects of an elapsed time when a fuel gas is supplied to a gas turbine from a gas mixer.

However, at present, although there are new ironmaking processes having been developed such as COREX process and FINEX process, a byproduct gas being generated in a new type of furnace using a new ironmaking process such as COREX process, FINEX process and the like (CFG: Corex Furnace Gas) has a significant fluctuation velocity and a large fluctuation band of calories. Therefore, in a conventional combustion control method for controlling the gas calories to be specific, the responsiveness thereof is decreased, which leads to unstable combustion or an accidental fire in a combustion system using a byproduct gas of a new type of blast furnace.

In addition, by being equipped with a feedforward control function as a fuel gas calorie control equipment being described in the Patent Application Laid-Open 2004-190632, it is possible to deal with a rapid change such as an unexpected disturbance and the like. However, in a case where CFG being a byproduct gas from a new type of furnace is mixed in, the fluctuations of the gas calories of CFG are rapid. Therefore, even though a conventional feedforward control is used, the values of the gas calorie fluctuations of a fuel gas cannot be sufficiently controlled. Moreover, because the responsiveness of a gas calorimeter is inferior and the time delay thereof is large, it is difficult to respond to rapid fluctuations of a byproduct gas being generated in the new type of blast furnace.

### SUMMARY OF THE INVENTION

It is an object of the present invention to provide a fuel gas calorie control equipment which controls the gas calories of a fuel gas so as to be specific by controlling the calorie fluctuations of a fuel gas having great calorie fluctuations, and provide a gas turbine system having such a fuel gas calorie control equipment as has been described.

In order to achieve the above-mentioned object, a fuel gas calorie control equipment in accordance with a preferred embodiment of the present invention is provided with: a first gas mixer mixing a first fuel gas and a second fuel gas; a first gas calorimeter measuring the gas calories of a mixed fuel gas being mixed in the first gas mixer; a feedback control section setting the ratio of the flow rates of the first and the second fuel gases so as to control the gas calories of the mixed fuel gas to be specific based on the measurement results of the first gas calorimeter; and a gas tank providing different time delays to the first fuel gas and mixing and supplying the first fuel gas being provided with different time delays to the first gas mixer.

Additionally, the gas turbine system in accordance with the present invention is provided with: a gas compressor compressing a fuel gas: an air compressor compressing the air; a combustor being provided with the fuel gas from the gas compressor and the air from the air compressor and refining combustion gas by burning the fuel gas and the air; a gas turbine being rotated and driven by the combustion gas from the combustor; and the aforesaid fuel gas calorie control equipment; wherein, the mixed fuel gas from the fuel gas calorie control equipment is supplied to the gas compressor, serving as a fuel gas.

In accordance with the present invention, by being equipped with a gas tank mixing a fuel gas being provided with different time delays, the fluctuation ratio of the gas calories of the fuel gas can be made moderate, thereby stabilizing the feedback control based on the measurement values of the gas calorimeter. In consequence, in controlling the gas calories of a mixed fuel gas that is obtained by mixing the fuel gas being supplied from the gas tank with another fuel gas to be specific, the fluctuations of the gas calories of the mixed fuel gas can be made small. In addition, by mixing a fuel gas once before being supplied to the gas tank and by controlling the gas calories of the fuel gas to be mixed by using the feedforward control function, it is possible to reduce high frequency component being included in the fluctuation ratio in the gas calories of a mixed fuel gas that will be necessary in the end. Moreover, by performing feedforward control using the gas calories of a fuel gas being exhausted from the gas tank, it is also possible to reduce high frequency component being included in the fluctuation ratio in the gas calories of the mixed fuel gas that will be necessary in the end. As has been described hereinabove, because the fluctuation ratio of the gas calories of a mixed fuel gas can be restrained and stabilized, stable combustion behavior can be achieved when the gas calorie control equipment in accordance with the present invention is used in a gas turbine system.

### DESCRIPTION OF THE DRAWINGS

FIG. 1 is a block diagram showing a construction of a gas turbine system in accordance with a first embodiment of the present invention.

FIG. 2 is a schematic block diagram showing a first configuration example of a gas tank.

FIG. 3 is a schematic block diagram showing a second configuration example of a gas tank.

FIG. 4 is a schematic block diagram showing a third configuration example of a gas tank.

FIG. 5 is a schematic block diagram showing a fourth configuration example of a gas tank.

FIG. 6 is a schematic block diagram showing a fifth configuration example of a gas tank.

FIG. 7 is a schematic block diagram showing a sixth configuration example of a gas tank.

FIG. 8 is a schematic block diagram showing a seventh configuration example of a gas tank.

FIG. 9 is a schematic block diagram showing an eighth configuration example of a gas tank.

FIG. 10 is a block diagram showing a construction of a gas turbine system in accordance with a second embodiment of the present invention.

FIG. 11 is a block diagram showing a construction of a gas turbine system in accordance with a third embodiment of the present invention.

### DESCRIPTION OF THE PREFERRED EMBODIMENTS

### First Embodiment

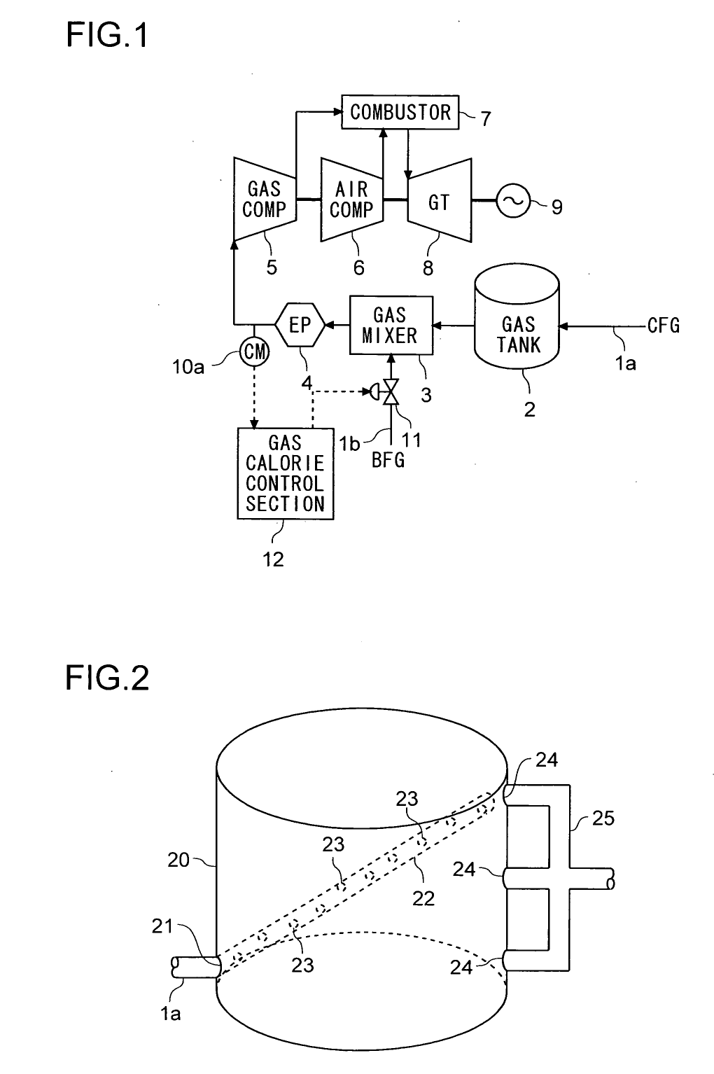

Referring now to the drawings, a first embodiment of the present invention will be described hereinafter. FIG. 1 is a block diagram showing the construction of a gas turbine system in accordance with the first embodiment.

A gas turbine system shown in FIG. 1 includes a CFG inlet pipe 1a supplying CFG being discharged from a new type of furnace (not being illustrated) such as a COREX furnace, a FINEX furnace and the like; a BFG inlet pipe 1b supplying BFG being discharged from a blast furnace; a gas tank 2 restraining the fluctuation ratio of the CFG being supplied from the CFG inlet pipe 1a; a gas mixer 3 mixing the CFG being discharged from the gas tank 2 with the BFG being supplied from the BFG inlet pipe 1b; and an electrical dust precipitator (EP) 4 collecting dusts and the like in a mixed gas being mixed of CFG and BFG in the gas mixer 3.

In a gas turbine system as described hereinabove, when the CFG being introduced from the CFG inlet pipe 1a is supplied to the gas tank 2, the CFG being provided with time delay in the gas tank 2 is mixed with the CFG which is not provided with time delay, thereby mechanically restraining the time fluctuation of the CFG. Specifically, the time fluctuation of the CFG is restrained by having the gas tank 2 mechanically constructed in a manner that the time until the CFG being supplied to the gas tank 2 is discharged from the gas tank 2 changes.

Then, when hte CFG being discharged from the gas tank 2 is supplied to a gas mixer 3, the CFG is mixed with BFG being supplied to the gas mixer 3 in the same manner, producing a mixed gas serving as a fuel gas. When the mixed gas is supplied to EP 4, high pressure direct electric current is charged between a discharge electrode and a dust collecting electrode and a corona discharge occurs inside thereof, which causes dusts being contained in the mixed gas to become charged with negative ions, thereby collecting the dusts and cleaning the mixed gas.

In addition, the gas turbine system described hereinabove includes a gas compressor 5 compressing the mixed gas being cleaned in EP4; an air compressor 6 compressing the air being supplied from outside; a combustor 7 being provided with the mixed gas and the air being compressed by the gas compressor 5 and the air compressor 6, respectively, and performing combustion; a gas turbine 8 being supplied with combustion gas being obtained by combustion in the combustor 7 so as to rotate; and a generator 9 converting a rotating energy of the gas turbine 8 to an electric energy.

Being constructed as described hereinabove, the gas compressor 5, the air compressor 6, the gas turbine 8 and the generator 9 are concentrically constructed, and the gas compressor 5, the air compressor 6 and the generator 9 rotate by rotation of the gas turbine 8. At this time, when a mixed gas from EP4 serving as a fuel gas is provided to the gas compressor, the mixed gas is compressed to be a high temperature and high pressure gas by the gas compressor 5 so as to be supplied to the combustor 7. Additionally, by having the outside air provided to the air compressor 6, the outside air is compressed to be a high temperature and high pressure air in the same manner so as to be supplied to the combustor 7.

Then, in the combustor 7, combustion gas is generated by having a mixed gas being supplied from the gas compressor 5 burned with the air being supplied from the air compressor 6 and is provided to the gas turbine 8. By having the gas turbine 8 rotate by the combustion gas from the combustor 7, the gas compressor 5, the air compressor 6 and the generator 9 rotate; the mixed gas and the air are compressed in the gas compressor 5 and the air compressor 6; and the rotating generator 9 generates electricity.

Moreover, the gas turbine system is provided with a gas calorimeter 10a measuring the gas calories of a mixed gas from EP4; a BFG flow control valve 11 being installed to the BFG inelt pipe 1b and setting the flow rate of the BFG being supplied to the gas mixer 3; and a gas calorie control section 12 setting the opening amount of the BFG flow control valve 11 based on the gas calories of a mixed gas being measured with the gas calorimeter 10a.

Being constructed as described hereinabove, when the gas calorie of a mixed gas from EP4 is measured with the gas calorimeter 10a, the gas calorie of the mixed gas being measured is supplied to the gas calorie control section 12. Then, first, in the gas calorie control section 12, the gas calorie of the mixed gas being measured with the gas calorimeter 10a is compared with the gas calorie being specified as an aimed value. Next, based on the deviation of the measured gas calorie of the mixed gas from the gas calorie being specified as the aimed value, the flow rate of the BFG that is to be supplied to the gas mixer 3 from the BFG inlet piping 1b is determined. Subsequently, by adjusting the opening amount of the BFG flow control valve 11 based on the determined BFG flow rate, the gas calorie of the mixed gas being discharged from EP4 is adjusted to be as specified as the aimed value.

Specifically, in the calorie control section 12, feedback control is performed for controlling the BFG flow rate by the gas calories of the mixed gas being measured with the gas calorimeter 10a. When the feedback control is performed as described hereinabove, PI control may be performed by adding an integral constituent and a derivative constituent to the deviation of the gas calorie of a mixed gas being measured with a gas calorimeter 10a from the gas calorie being specified as the aimed value. In addition, in each of the following embodiments including the present embodiment, a gas calorimeter having such a high responsiveness is used as can respond in one minute and several seconds.

A construction of a gas tank 2 in the gas turbine system as described hereinabove will be described hereafter. FIG. 2 through FIG. 9 are schematic diagrams showing each configuration example of the gas tank 2.

### 1. FIRST CONFIGURATION EXAMPLE

A first configuration of a gas tank 2 will be described by referring to FIG. 2. The gas tank shown in FIG. 2 is provided with a cylindrical chassis 20 mixing the CFG being supplied from a CFG inlet pipe 1a and provided with time delay; a CFG inlet port 21 being connected to the CFG inlet pipe 1a; a CFG piping for time delay 22 being connected to the CFG inlet port 21 and provided with a plurality of nozzle holes 23; a plurality of CFG outlet ports 24 discharging the CFG being mixed in the chassis 20; and a CFG discharge piping 25 connecting a plurality of the CFG outlet ports 24 and being connected to a piping to a gas mixer 3. In addition, in FIG. 2, portions being constructed inside the chassis 20 are illustrated with dotted lines.

The gas tank 2 has a CFG inlet port 21 provided to the neighborhood of one end surface on the side surface of the chassis 20, and at the same time, the CFG outlet ports 24 are provided to the location being the opposite to the position where the CFG inlet port 21 is provided on the side surface of the cassis 20. At this time, a plurality of the CFG outlet ports 24 are provided to the side surface of the chassis 20, being equally spaced between both end surfaces. In addition, the CFG piping for time delay 22 is constructed so as to be connected to the CFG inlet port 21 and to extend toward the CFG outlet ports 24 being provided to the position being apart from the CFG inlet port 21. Then, the CFG piping for time delay 22 has a plurality of nozzle holes 23 formed on the outer circumference surface thereof in a manner that a part of the CFG flowing through the CFG piping for time delay 22 leaks from the piping.

When the gas tank 2 is constructed as described hereinabove, in the CFG piping for time delay 22, the distances from the nozzle holes 23 on the side of the CFG inlet port 21 to the CFG outlet ports 24 are different from the distances from the nozzle holes 23 on the side of the CFG outlet pots 24 to the CFG outlet ports 24. In addition, the CFG piping for time delay 22 is formed so as to reach the neighborhood of the CFG outlet ports 24, and the nozzle holes 23 are provided to the edge portion being opposite to the edge portion being connected to the CFG inlet port 21. Also, each of the CFG outlet ports 24 has a different distance to the CFG inlet port 21.

At this time, while the CFG being introduced from the CFG inlet port 21 is flowing through the CFG piping for time delay 22, a part thereof leaks through the nozzle holes 23, respectively. Then, the CFG leaking from each of the nozzle holes 23 flows toward the CFG outlet ports 24, respectively. Here, because the distance of the CFG flowing from each of the nozzle holes 23 to each of the CFG outlet ports 24 respectively differs, the CFG's being different in time to be introduced to the CFG inlet port 21 reach the CFG outlet ports 24 simultaneously. Specifically, by having a part of the CFG from each of the nozzle holes 23 of the CFG piping for time delay 22 leak, a part of the CFG being introduced from the CFG inlet port 21 can reach the CFG outlet ports 24 with a part of the CFG being introduced from the CFG inlet port 21 delayed.

Consequently, at the CFG outlet ports 24, the CFG's being introduced from the CFG inlet port 21 at different times are mixed and discharged to the CFG discharge piping 25. In addition, because each of the CFG outlet ports 24 is provided to a position being relatively different from the position of the CFG inlet port 21, each CFG that is to be mixed by being discharged to the CFG discharge piping 25 from each of the CFG outlet ports 24 respectively will become a CFG being introduced to the CFG inlet port 21 at a different time. As a result, the CFG's being delayed by the CFG discharge piping 25 are further mixed in the CFG discharge piping 25.

By mixing the CFG's being introduced to the CFG inlet port 21 at different times as described hereinabove, the CFG's having different gas calories are mixed. Therefore, the CFG being supplied to a gas mixer 3 through the CFG discharge piping 25 of a gas tank 2 has the fluctuation ratio of the gas calories thereof mitigated, compared with the fluctuation ratio of the gas calories of the CFG being supplied from the CFG inlet piping 1a. In consequence, the fluctuation ratio of the gas calories of a mixed gas being obtained by mixing the CFG having the fluctuation ratio of the gas calories thereof mitigated with a BFG in the gas mixer 3 can be restrained, too.

### 2. SECOND CONFIGURATION EXAMPLE

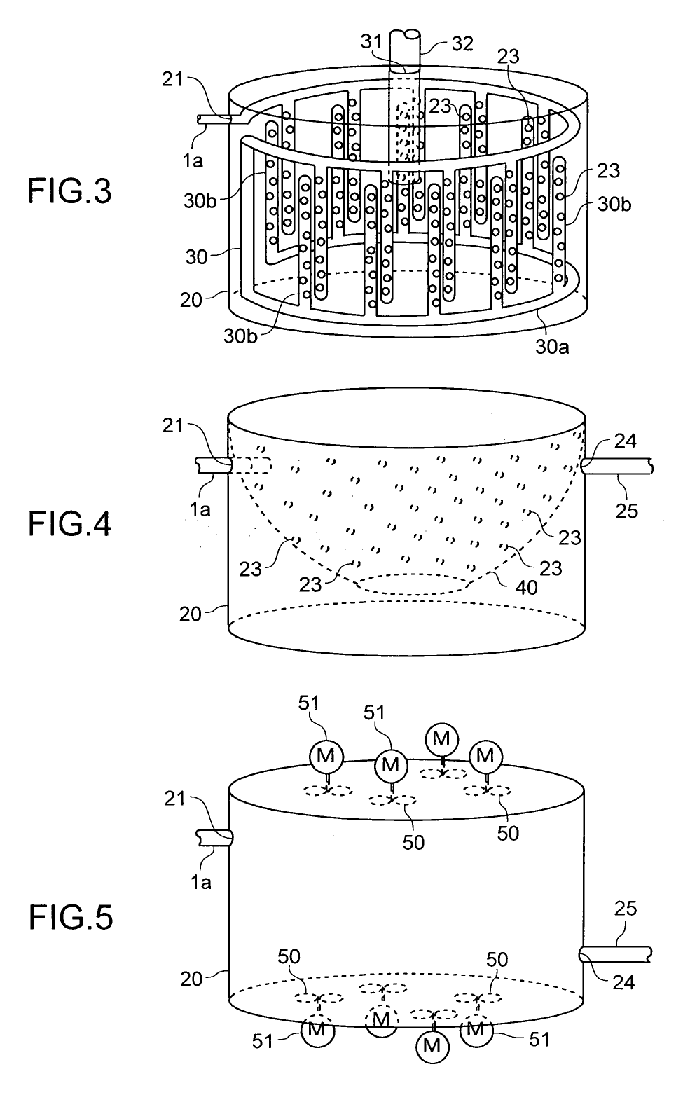

A second configuration example of a gas tank 2 will be described by referring to FIG. 3. In the construction in FIG. 3, same portions as in the construction in FIG. 2 will be provided with same symbols, and detailed description thereof will be omitted. The gas tank 2 shown in FIG. 3 is provided with a chassis 20; a CFG inlet port 21; a CFG piping for time delay 30 being connected to the CFG inlet port 21 and provided with a plurality of nozzle holes 23; a CFG outlet port 31 to discharge the CFG being mixed in the chassis 20; and a CFG discharge piping 32 being inserted into the CFG outlet port 31 and connected to a piping to the gas mixer 3. In FIG. 3, the construction of the interior of the chassis 20 is illustrated with solid lines and each component inside the chassis 20 being overlapped is illustrated with a dotted line.

When a gas tank 2 is constructed as described hereinabove, the CFG piping for time delay 30 is provided with a main pipe 30a being formed so as to be along the boundary line between the side surface of the chassis 20 and each of the upper end surface and the lower end surface respectively and with a plurality of branch pipes 30b protruding from the main pipe 30a and being formed so as to be in parallel with the side surface of the chassis 20 from one end surface of the chassis 20 toward the other end surface. In addition, each side surface and each edge portion of the main pipe 30a and the branch pipes 30b have a plurality of nozzle holes 23 provided, and a part of the CFG flowing through the main pipe 30a and the branch pipes 30b leaks into the inside of the chassis 20.

At this time, the main pipe 30a is provided with a section being formed so as to be connected to the CFG inlet port 21 being provided to the upper end surface side of the side surface of the chassis 20 and to be along the boundary line between the side surface and the upper end surface of the chassis 20 for approximately one outer circumference of the upper end surface of the chassis 20; a section being formed so as to be along the boundary line between the side surface and the lower end surface of the chassis 20 for approximately one outer circumference of each of the upper end surface and the lower end surface of the chassis 20; and a section connecting sections being formed so as to be along each of the outer circumference of the upper end surface and the lower end surface of the chassis 20, respectively. Then, a plurality of branch pipes 30b are formed in each of the sections of the main pipe 30a being formed so as to be along the outer circumferences of the upper end surface and the lower end surface of the chassis 20 respectively.

Additionally, the CFG outlet port 31 is provided in the center of the upper end surface of the chassis 20, and the CFG discharge piping 32 is inserted into the center portion of the chassis 20 through the CFG outlet port 31. Specifically, the branch pipes 30b of the CFG piping for time delay 30 are installed so as to surround the outer circumference of the discharge piping 32 with the discharge piping 32 serving as the center, and the section being formed so as to be along the outer circumference of the upper end surface of the chassis 20 in the main pipe 30a of the CFG piping for time delay 30 is formed so as to surround the CFG outlet port 31.

Because the CFG flowing through the CFG piping for time delay 30 leaks into the chassis 20 through any of the nozzle holes 23 and flows into the inside of the CFG discharge piping 32 by having the CFG piping for time delay 30 constructed as described hereinabove, a plurality of pathways where the CFG flows from the CFG inlet port 20 to the CFG outlet port 31 can be formed inside the chassis 20. Then, because the construction of the CFG discharge piping 32 is made complicated and the nozzle holes 23 are provided to various positions in the CFG discharge piping 32, the distance of a plurality of pathways of the CFG flowing from the CFG inlet port 20 to the CFG outlet port 31 can have a variety of length. Consequently, the CFG's being supplied to the gas tank 2 from the CFG inlet port 20 at different times flow into the CFG discharge piping 32, and the CFG's being supplied to the gas tank 2 at different times are mixed, thereby restraining the fluctuation ratio of the gas calories of the CFG's.

### 3. THIRD CONFIGURATION EXAMPLE

A third configuration example of a gas tank 2 will be described by referring to FIG. 4. In the construction in FIG. 4, same portions as in the construction in FIG. 2 will be provided with same symbols, and detailed description thereof will be omitted. The gas tank 2 shown in FIG. 4 is provided with a chassis 20; a CFG inlet port 21; a CFG outlet port 24; a CFG discharge piping 25; and a tapered inner cylinder 40 being connected to the CFG inlet pipe 1a being inserted through the CFG inlet port 21 and having a plurality of nozzle holes 23. In FIG. 4, portions being constructed inside the chassis 20 are illustrated with dotted lines.

When a gas tank 2 is constructed as described hereinabove, the inner cylinder 40 is formed so as to be tapered toward the center of the chassis 20 from the boundary line between the upper end surface and the side surface of the chassis 20. Then, by having the upper end surface of the inner cylinder 40 serve as the upper end surface of the chassis 20 and forming the lower edge of the inner cylinder 40 at a position being adjacent to the lower end surface of the chassis 20, the space inside the chassis 20 is divided into two regions, the inside and the outside of the inner cylinder 40. In addition, the lower end of the inner cylinder 40 is put into free condition. Then, a plurality of nozzle holes 23 are formed on the side surface of the inner cylinder 40, and at the same time, the CFG inlet pipe 1a being inserted through the CFG inlet port 21 is connected so as to be along the side surface of the inner cylinder 40. Moreover, the CFG outlet port 24 is provided to the upper end surface of the side surface of the chassis 20, and at the same time, a CFG discharge piping 25 is connected to the CFG outlet port 24.

Because by having the inner cylinder 40 installed, the CFG being introduced into the inside region of the inner cylinder 40 from the CFG inlet pipe 1a flows along the side surface of the inner cylinder 40, a rotational flow is generated by the CFG in the inside region of the inner cylinder 40, and after flowing to the lower end of the inner cylinder 40, the CFG flows out to the outside region of the inner cylinder 40 from the lower end of the inner cylinder 40. At this time, a part of the CFG flowing along the side surface of the inner cylinder 40 leaks to the outside region of the inner cylinder 40 through a plurality of the nozzle holes 23 being formed on the side surface of the inner cylinder 40. In consequence, after the CFG leaking from the nozzle holes 23 is mixed with the CFG flowing out from the lower end of the inner cylinder 40 in the outside region of the inner cylinder 40, the mixed CFG is discharged to the CFG discharge piping 25 through the CFG outlet port 24.

By having such an inner cylinder 40 as described hereinabove constructed inside the chassis 20, the CFG's being supplied to the gas tank 2 from the CFG inlet port 20 at different times flow to the CFG discharge piping 25 and the CFG's being supplied to the gas tank 2 at different times are mixed, thereby restraining the fluctuation ratio of the gas calories of the CFG's.

### 4. FOURTH CONFIGURATION EXAMPLE

A fourth configuration example of a gas tank 2 will be described by referring to FIG. 5. In the construction in FIG. 5, same portions as in the construction in FIG. 2 will be provided with same symbols, and detailed description thereof will be omitted. The gas tank 2 shown in FIG. 5 is provided with a chassis 20; a CFG inlet port 21; a CFG outlet port 24; a CFG discharge piping 25; a plurality of fans 50 mixing the CFG's being introduced into the chassis 20 by diffusing; and a plurality of motors 51 rotating the fans 50, respectively. In FIG. 5, portions being constructed inside the chassis 20 are illustrated with dotted lines.

When a gas tank 2 is constructed as described hereinabove, a CFG inlet port 21 is provided in the neighborhood of one end surface (the upper end surface in FIG. 5) of the side surface of the chassis 20, and at the same time, a CFG outlet port 24 is provided in the neighborhood of the other end surface (the lower end surface in FIG. 5) of the side surface of the chassis 20, being opposite to the position where the CFG inlet port 21 is provided on the side surface of the chassis 20. Then, the fans 50 are provided to both end surfaces of the chassis 20 inside the chassis 20, and at the same time, the motors 51 being connected to the shaft of each of the fans 50 are installed to both end surfaces of the chassis 20 outside the chassis 20.

By having such fans 50 and motors 51 as described hereinabove installed, the CFG being supplied to the inside of the chassis 20 from the CFG inlet pipe 1a through the CFG inlet port 21 is diffused by a plurality of the fans 50 being rotated by the motors 51. Consequently, by having the CFG's being sufficiently diffused inside the chassis 20 mixed, the CFG's being supplied to the gas tank 2 from the CFG inlet port 20 at different times through the CFG outlet port 2 flows into the CFG discharge piping 25 and the CFG's being supplied to the gas tank 2 at different times are mixed, thereby restraining the fluctuation ratio of the gas calories of the CFG's.

### 5. FIFTH CONFIGURATION EXAMPLE

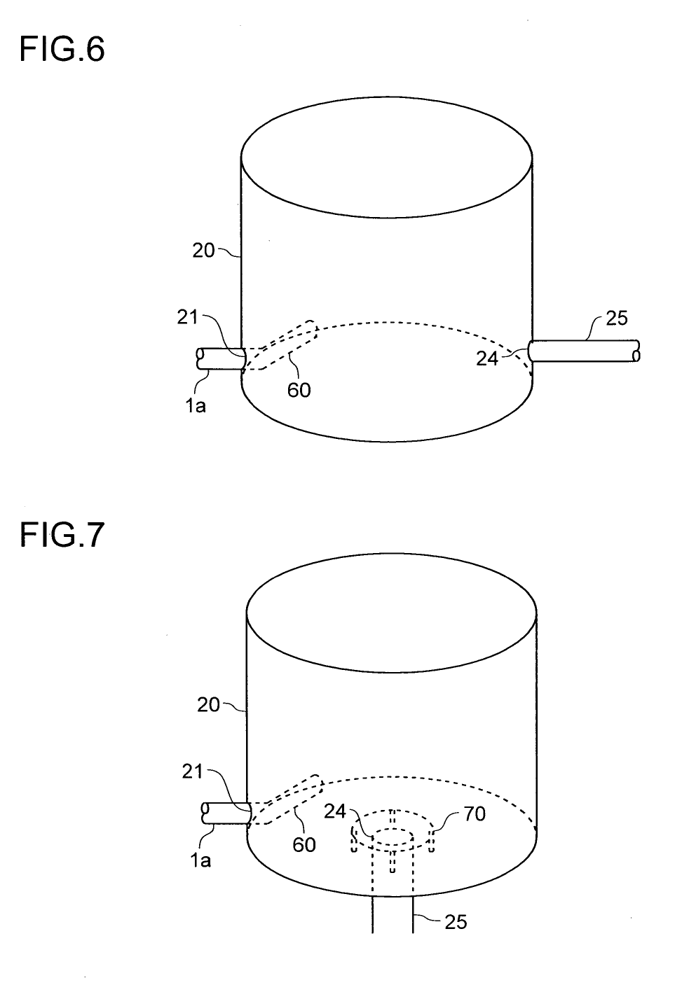

A fifth configuration example of a gas tank 2 will be described by referring to FIG. 6. In the construction in FIG. 6, same portions as in the construction in FIG. 2 will be provided with same symbols, and detailed description thereof will be omitted. The gas tank 2 shown in FIG. 6 is provided with a chassis 20; a CFG inlet port 21; a CFG outlet port 24; a CFG discharge piping 25; and a nozzle 60 being installed to the edge of the CFG inlet pipe 1a being inserted into the inside of the chassis 20 from the CFG inlet port 21. In FIG. 6, portions being constructed inside the chassis 20 are illustrated with dotted lines.

When the gas tank 2 is constructed as described hereinabove, the CFG inlet port 21 and the CFG outlet port 24 are provided to the lower end surface of the side surface of the chassis 20 so as to be opposite to each other across the center of the lower end surface of the chassis 20 and to be approximately at the same level. In addition, the nozzle 60 being installed to the edge of the CFG inlet pipe 1a is provided with a predetermined elevation angle (for example, 45 degrees) with respect to the lower end surface of the chassis 20, and the length from the connection portion of the nozzle 60 to the CFG inlet pipe 1a to the edge thereof is to be constant number of times (for example, approximately three times) as much as the diameter of the nozzle 60.

Then, the nozzle 60 is installed so as to head for the central axis connecting the centers of the lower end surface and the upper end surface of the chassis 20. By installing the nozzle 60 as is described hereinabove, when the CFG being introduced from the CFG inlet pipe 1a is supplied to the inside of the chassis 20 from the edge of the nozzle 60, the CFG being introduced from the CFG inlet pipe 1a is discharged from the lower end surface to the upper end surface of the chassis 20. Meanwhile, because the CFG outlet port does not exist on the extension line of the edge of the nozzle 60, the pathway from the nozzle 60 to the CFG outlet port 24 becomes long.

Therefore, in the present configuration example, when the CFG's being introduced from the CFG inlet pipe 1a are discharged to the inside of the chassis 20 from the nozzle 60, it takes time to reach the CFG outlet port 24 being provided to the lower end surface of the chassis 20, which causes delays. In addition, at this time, the surrounding CFG's remaining inside the chassis 20 along the jet flow being caused by the CFG's being discharged from the nozzle 60 are caught in, which mix the CFG's being supplied to the inside of the chassis 20 at different times. As a result, in the present configuration example, the CFG's being supplied to the gas tank 2 at different times are mixed, thereby restraining the fluctuation ratio of the gas calories of the CFG's.

### 6. SIXTH CONFIGURATION EXAMPLE

A sixth configuration example of a gas tank 2 will be described by referring to FIG. 7. In the construction in FIG. 7, same portions as in the construction in FIG. 6 will be provided with same symbols, and detailed description thereof will be omitted. The gas tank 2 shown in FIG. 7 is provided with a chassis 20; a CFG inlet port 21; a CFG outlet port 24; a CFG discharge piping 25; a nozzle 60; and a blocking plate 70 being installed so as to cover the CFG outlet port 24. In FIG. 7, portions being constructed inside the chassis 20 are illustrated with dotted lines.

When the gas tank 2 is constructed as described hereinabove, being different from the fifth configuration example, the CFG outlet port 24 is provided in the center of the lower end surface of the chassis 20. In addition, the blocking plate 70 being installed so as to cover the upper side of the CFG outlet port 20 is placed at a little higher position than the lower end surface of the chassis 20, making a space between the blocking plate 70 and the CFG outlet port 24. Moreover, same as the fifth configuration example, the nozzle 60 is constructed so as to head for the central axis of the chassis 20, have a predetermined elevation angle and have a length being constant number of times as much as the diameter of thereof.

Therefore, in the present configuration example, first of all, when the CFG's being introduced from the CFG inlet pipe 1a are supplied to the inside of the chassis 20 from the edge of the nozzle 60, the CFG's are discharged from the lower end surface to the upper end surface of the chassis 20, and the surrounding CFG's remaining inside the chassis 20 along the jet flow being caused by the CFG's being discharged from the nozzle 60 are caught in. Additionally, by having a blocking plate installed over the top of the CFG outlet port 24, it is necessary for the CFG's being discharged from the CFG outlet port 24 to surround the blocking plate 70, which prevents the CFG's from constructing a space to stay inside the chassis 20 as well as further mixes the CFG's.

### 7. SEVENTH CONFIGURATION EXAMPLE

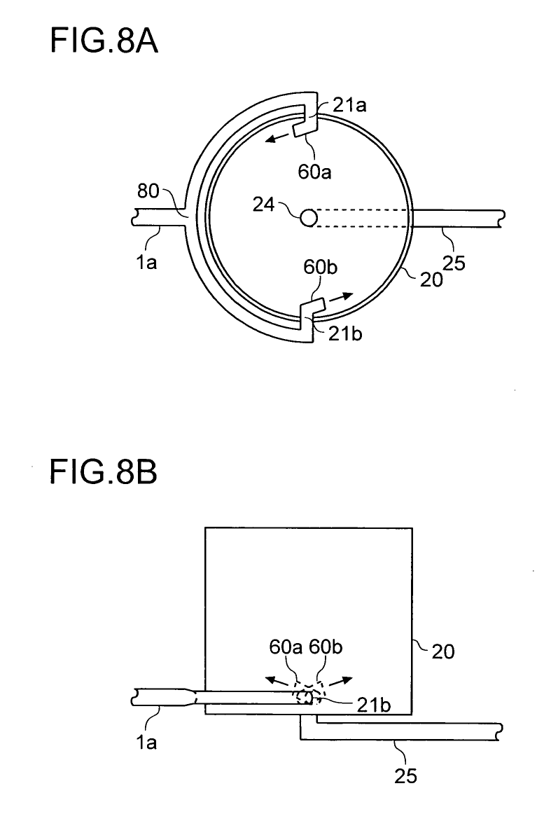

A seventh configuration example of a gas tank 2 will be described by referring to FIG. 8. In the construction in FIG. 8, same portions as in the construction in FIG. 7 will be provided with same symbols, and detailed description thereof will be omitted. The gas tank 2 shown in FIG. 8 is provided with a chassis 20; a CFG outlet port 24; a CFG discharge piping 25; two CFG inlet ports 21a and 21b being provided to positions being apart each other on the side surface of the chassis 20; and nozzles 60a and 60b being provided to the edges of the CFG inlet pipe 1a being inserted from the CFG inlet ports 21a and 21b, respectively. In FIG. 8, FIG. 8 (a) is a plane cross-sectional view being seen from the top of the gas tank 2, and FIG. 8 (b) shows a front view of the gas tank 2.

Wherein, as shown in FIG. 8 (a), the positional relation between the CFG inlet ports 21a and 21b is to be such as the center of the lower end surface of the chassis 20 falls on the straight line connecting each other. Specifically, the CFG inlet ports 21a and 21b are placed so as to be equally spaced against the circumferential direction of the side surface of the chassis 20. Additionally, in FIG. 8 (a), a diverging point 80 is provided to a position where the distances from the diverging point 80 of the CFG inlet pipe 1a to the CFG inlet ports 21a and 21b, respectively are the same. However, the diverging point 80 may be provided to a position where the distances from the diverging point 80 to the CFG inlet ports 21a and 21b, respectively are different. Moreover, as shown in FIG. 8 (b), the CFG inlet ports 21a and 21b are provided to the lower end surface of the side surface of the chassis 20, and at the same time, the CFG outlet port 24 is provided to the center of the lower end surface of the chassis 20 in the same manner as the sixth configuration example.

In the present configuration example, being different from the fifth and the sixth configuration examples, the directions of the nozzles 60a and 60b face along the circumferential direction of the side surface of the chassis 20, and at the same time, the nozzles 60a and 60b face the same direction against the circumferential direction of the side surface of the chassis 20 (the anticlockwise direction in the example of FIG. 8 (a)). Additionally, the elevation angle of each of the nozzles 60a and 60b, respectively, with respect to the lower end surface of the chassis 20 is to be smaller than the elevation angles of the fifth and the sixth configuration examples (13 degrees, for example), as shown in FIG. 8 (b). Moreover, same as the fifth and the sixth configuration examples, the length of the nozzles 60a and 60b may be constant number of times (three times, for example) as much as the diameters of the nozzles 60a and 60b. By having the nozzles 60a and 60b constructed as are described hereinabove, when the CFG's being supplied from the CFG inlet pipe 1a are injected toward the upper end surface of the chassis 20 from the nozzles 60a and 60b, a rotating force which rotate the CFG's in the circumferential direction of the side surface of the chassis 20 (an anticlockwise rotating force in the example of FIG. 8 (a)) is provided, so that the surrounding CFG's remaining inside the chassis 20 will be caught in and mixed, subsequently being discharged to the outside from the CFG outlet port 24 in the center of the lower end surface of the chassis 20.

### 8. EIGHTH CONFIGURATION EXAMPLE

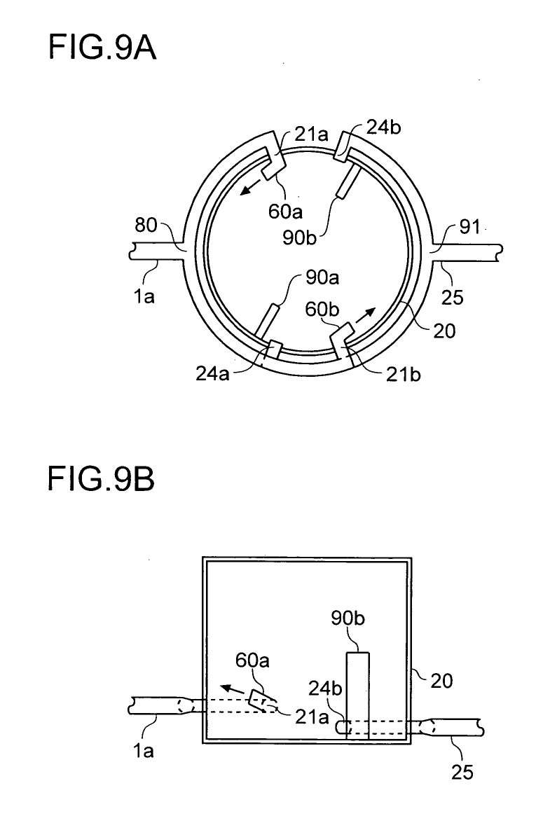

An eighth configuration example of a gas tank 2 will be described by referring to FIG. 9. In the construction in FIG. 9, same portions as in the construction in FIG. 8 will be provided with same symbols, and detailed description thereof will be omitted. The gas tank 2 shown in FIG. 9 is provided with a chassis 20; CFG inlet ports 21a and 21b; nozzles 60a and 60b; two CFG outlet ports 24a and 24b being provided to the positions being away from each other on the side surface of the chassis 20; a CFG discharge piping 25 being connected to the CFG outlet ports 24a and 24b; and blocking plates 90a and 90b being installed so as to block the flow of the CFG's flowing from the CFG inlet ports 21a and 21b to the CFG outlet ports 24a and 24b. In addition, in FIG. 9, FIG. 9 (a) is a plane cross-sectional view of a gas tank 2 being seen from the top thereof, and FIG. 9 (b) shows a front cross-sectional view of the gas tank 2.

Wherein, as shown in FIG. 9 (a), the positional relation between the CFG inlet ports 21a and 21b is to be such as the center of the lower end surface of the chassis 20 falls on the straight line connecting each other in the same manner as the seventh configuration example. Specifically, the CFG inlet ports 21a and 21b are placed so as to be equally spaced against the circumferential direction of the side surface of the chassis 20. Additionally, in the present configuration example, being different from the seventh example, as shown in FIG. 9 (a), the CFG inlet pipe 1a has the diverging point 80 thereof provided to a position where the distances from the diverging point 80 to the CFG inlet ports 21a and 21b, respectively are different. Moreover, the diverging point 80 of the CFG inlet pipe 1a may be provided to a position where the distances from the diverging point 80 to the CFG inlet ports 21a and 21b, respectively are the same.

In addition, as shown in FIG. 9 (a), the positional relation between the CFG outlet ports 24a and 24b is to be such as the center of the lower end surface of the chassis 20 falls on the straight line connecting each other. Specifically, the CFG outlet ports 24a and 24b are placed so as to be equally spaced against the circumferential direction of the side surface of the chassis 20. Also, in FIG. 9 (a), a diverging point 91 is provided to a position where the distances from the diverging point 91 of the CFG discharge piping 25 to the CFG outlet ports 24a and 24b, respectively are different. However, the diverging point 91 may be provided to a position where the distances from the diverging point 91 to the CFG outlet ports 24a and 24b, respectively are the same.

Furthermore, when the CFG inlet ports 21a and 21b and the CFG outlet ports 24a and 24b are provided as described hereinabove, the CFG outlet port 24b is installed in the neighborhood of the CFG inlet port 21a, and at the same time, the CFG outlet port 24a is installed in the neighborhood of the CFG inlet port 21b. Specifically, the CFG inlet ports 21a and 21b and the CFG outlet ports 24a and 24b are placed alternately against the circumferential direction of the side surface of the chassis 20 in such a sequence as the CFG inlet port 21a, the CFG outlet port 24b, the CFG inlet port 21b and the CFG outlet port 24a.

Additionally, the direction of the nozzle 60a being installed to the edge of the CFG inlet pipe 1a being inserted into the CFG inlet port 21a is set to face the CFG outlet port 24a along the circumferential direction of the side surface of the chassis 20, and at the same time, the direction of the nozzle 60b being installed to the edge of the CFG inlet pipe 1a being inserted into the CFG inlet port 21b is set to face the CFG outlet port 24b along the circumferential direction of the side surface of the chassis 20. Specifically, in the example of FIG. 9 (a), the CFG inlet ports 21a and 21b and the CFG outlet ports 24a and 24b are placed clockwise in such a sequence as the CFG inlet port 21a, the CFG outlet port 24b, the CFG inlet port 21b and the CFG outlet port 24a, and at the same time, the nozzles 60a and 60b face to the direction so as to inject the CFG's anticlockwise.

Moreover, as shown in FIG. 9 (b), same as the seventh configuration example, the nozzles 60a and 60b have elevation angles with respect to the lower end surface of the chassis 20 which are smaller than the elevation angles in the fifth and the sixth configuration examples. In addition, the length of the nozzles 60a and 60b may be constant number of times (three times, for example) as much as the diameter of the nozzles 60a and 60b in the same manner as the fifth and the sixth configuration examples. Also, as shown in FIG. 9 (b), the CFG inlet ports 21a and 21b and the CFG outlet ports 24a and 24b are provided to the lower end surface of the side surface of the chassis 20, and at the same time, the CFG inlet ports 21a and 21b are provided so as to be above the CFG outlet ports 24a and 24b

Then, the pathway along the circumferential direction of the side surface of the chassis 20 from the CFG inlet port 21a to the CFG outlet port 24a has a blocking plate 90a installed to the lower end surface of the chassis 20 in the neighborhood of the CFG outlet port 24a; and the pathway along the circumferential direction of the side surface of the chassis 20 from the CFG inlet port 21b to the CFG outlet port 24b has a blocking plate 90b installed to the lower end surface of the chassis 20 in the neighborhood of the CFG outlet port 24b. Furthermore, the height of the blocking plates 90a and 90b from the lower end surface of the chassis 20 is approximately half as the height of the chassis 20. In addition, the height of the blocking plates 90a and 90b from the lower end surface of the chassis 20 is such as the flow of the CFG's flowing into the CFG outlet ports 24a and 24b is blocked, and the higher the height of the blocking plates 90a and 90b are, the more the mixing ratio of the CFG's is increased.

By having the construction as described hereinabove, when the CFG's being supplied from the CFG inlet pipe 1a are injected toward the upper end surface of the chassis 20 from the nozzles 60a and 60b, a rotating force which rotates the CFG's in the circumferential direction of the side surface of the chassis 20 (an anticlockwise rotating force in the example of FIG. 8 (a)) is provided, so that the surrounding CFG's remaining inside the chassis 20 will be caught in and mixed. Then, the CFG's being mixed flows toward and into the CFG outlet ports 24a and 24b, going around the blocking plates 90a and 90b, thereby enhancing the mixing ratio further.

Additionally, the fans 50 and the motors 51 being installed to the gas tank 2 in the fourth configuration example may be provided to a gas tank 2 in the first and the second configuration examples having the CFG piping for time delay 22 and 30 installed inside the chassis 20, to a gas tank 2 in the third configuration example having an inner cylinder 40 installed inside the chassis 20, and to a gas tank 2 in the fifth through the eighth configuration examples having the nozzles 60, 60a and 60b installed thereto. Also, in the second through the fourth configuration examples, as in the first configuration example, a plurality of the CFG outlet ports 24 and 31 are provided, and each of the CFG outlet ports 24 and 31 may be connected by the CFG discharge piping 25 and 32.

Moreover, in the fifth and the sixth configuration examples, same as in the seventh or the eighth configuration example, the CFG inlet pipe 1a may diverge and at the same time, a plurality of the CFG inlet ports 21 may be provided to the side surface of the chassis 20 in the circumferential direction thereof. Then, each of the edges of the CFG inlet pipe 1a that is to be inserted into a plurality of the CFG inlet ports 21 is provided with a nozzle 60 facing toward the central axis of the chassis 20.

Additionally, in the seventh or the eight configuration example, not only two CFG inlet ports 21a and 21b but a plurality of more than two CFG inlet ports 21 may be provided so as to be equally spaced in the circumferential direction of the side surface of the chassis 20. Then, each of the edges of the CFG inlet pipe 1a being inserted into a plurality of the CFG inlet ports 21 is provided with the nozzle 60 facing toward the direction along the circumferential direction of the side surface of the chassis 20. Moreover, in the eighth configuration example, a plurality of the CFG inlet ports 21 and the CFG outlet ports 24 may be provided so as to be equally spaced in the circumferential direction of the side surface of the chassis 20, respectively. At this time, the CFG inlet ports 21 and the CFG outlet ports 24 are placed alternately along the circumferential direction of the side surface of the chassis 20, and at the same time, blocking plates are provided so as to block the pathways along the circumferential direction of the side surface of the chassis 20 from the CFG inlet ports to the CFG outlet ports.

Moreover, in the fifth configuration example, when the CFG inlet port 21 and the CFG outlet port 24 have approximately same height and at the same time, the CFG outlet port 24 is not placed on an extension line of the direction of the nozzle 60, the CFG inlet port and the CFG outlet port 24 may be placed at the positions other than the lower end surface of the side surface of the chassis 20. Furthermore, in the first through the eighth configuration examples, by forming a plurality of the pathways of the CFG's inside the chassis 20, the CFG's being supplied to the inside of the gas tank 2 are agitated. However, a pathway may be formed outside the chassis 20 for having a part of the CFG's being supplied to the inside of the chassis 20 return to the chassis 20 after being discharged to the outside temporarily by a blower and the like. At this time, the CFG's passing through the pathways outside the chassis 20 and the CFG's remaining inside the chassis 20 are mixed, resulting in agitation of the CFG's.

### Second Embodiment

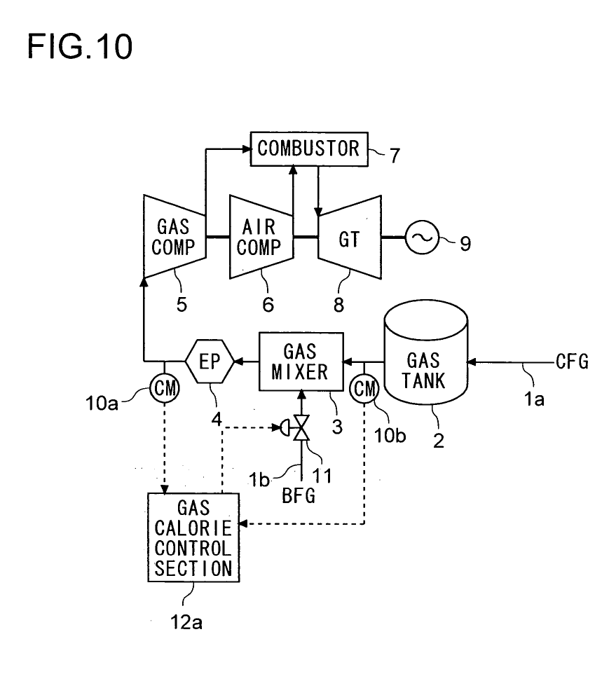

A second embodiment of the present invention will be described by referring to the drawings. FIG. 10 is a block diagram showing a construction of a gas turbine system with the present embodiment. In the construction shown in FIG. 10, same portions as in the construction in FIG. 1 will be provided with same symbols, and detailed description thereof will be omitted. In addition, a gas tank being constructed as shown in the first through the eighth configuration examples (See FIG. 2 through FIG. 9.) in accordance with the first embodiment will be used for a gas tank in the gas turbine system with the present embodiment, and detailed description thereof will be omitted.

The gas turbine system in FIG. 10 is a gas turbine system in accordance with the first embodiment (See FIG. 1.), being added with a gas calorimeter 10b which measures the gas calories of the CFG's being discharged after being provided with an effect of time delay in the gas tank 2 as well as being equipped with, in place of the gas calorie control section 12, a gas calorie control section 12a which sets the opening amount of the BFG flow control valve 11 based on the measurement results of the gas calorimeters 10a and 10b.

Having the construction as described hereinabove, same as the first embodiment, in the gas calorie control section 12a, feedback control is performed, based on the deviation of the gas calories of a mixed gas from EP4 being measured with the gas calorimeter 10a from the aimed gas calories of a mixed gas. When the feedback control controlling the BFG flow rate is performed, based on the gas calories of a mixed gas being measured with the gas calorimeter 10a, feedforward control is performed simultaneously, based on the gas calories of the CFG's being discharged from the gas tank 2 and measured with the gas calorimeter 10b.

In the feedforward control by the gas calorie control section 12a, when the gas calories of the CFG's being discharged from the gas tank 2 are measured with the gas calorimeter 10b, the gas calories of the CFG's being supplied to a gas mixer 3 is confirmed beforehand based on the time for the CFG's to reach the gas mixer 3 from the gas calorimeter 10b being estimated on the gas flow rate of the CFG's and on the gas calories of the CFG's being measured with the gas calorimeter 10b. Then, the opening amount of the BFG flow control valve 11 being determined by the feedback control on the basis of the measurement values with the gas calorimeter 10a is corrected, based on the gas calories of the CFG's being supplied to the gas mixer 3 at the present moment when estimation is made by the feedforward control on the basis of the measurement values with the gas calorimeter 10b.

As described hereinabove, same as the first embodiment, first, the gas turbine system with the present embodiment reduces the frequency and amplitude of the fluctuation constituents of the gas calories of a mixed gas being supplied to a gas compressor 5 by mechanical construction of the gas tank 2 and can further restrain the amplitude of the low frequencies of the gas calories of the mixed gas by the feedback control based on the measurement values with the gas calorimeter 10a. In consequence, by adding the feedforward control on the basis of the measurement values with the gas calorimeter 10b, the amplitude of the high frequencies overlapping the low frequencies of the gas calories of the mixed gas can be restrained furthermore.

### Third Embodiment

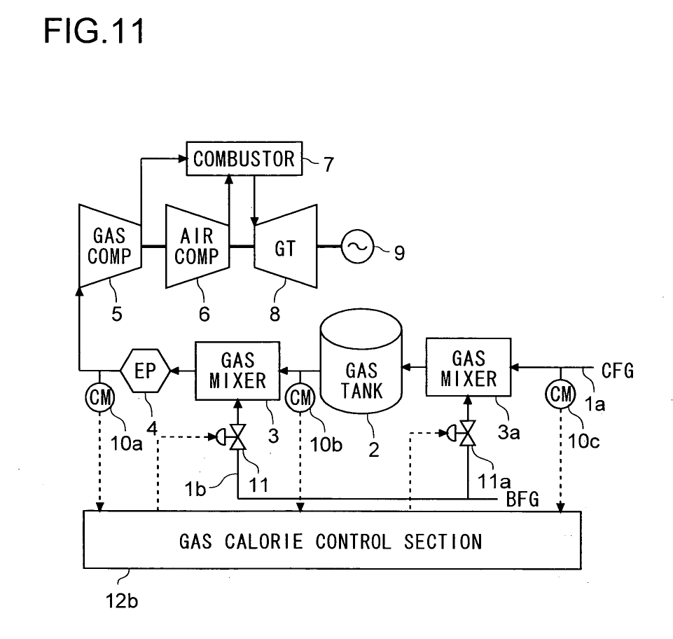

A third embodiment of the present invention will be described by referring to the drawings. FIG. 11 is a block diagram showing the construction of a gas turbine system in accordance with the present embodiment. In the construction in FIG. 11, same portions as in the construction of FIG. 10, same symbols will be provided, and detailed explanation thereof will be omitted. In addition, a gas tank being constructed as shown in the first through the eighth configuration examples (See FIG. 2 through FIG. 9.) in accordance with the first embodiment will be used for a gas tank in the gas turbine system with the second embodiment, and detailed description thereof will be omitted.

A gas turbine system in FIG. 11 is a gas turbine system in accordance with the second embodiment (See FIG. 10.), being added with a gas calorimeter 10c which measures the gas calories of the CFG's passing through the CFG inlet pipe 1a before being supplied to the gas tank 2; a gas mixer 3a mixing the CFG's passing through the CFG inlet pipe 1a with a part of the BFG from the BFG inlet pipe 1b; and a BFG flow control valve 11a setting the flow rate of the BFG being supplied to the gas mixer 3a as well as being equipped with, in place of the gas calorie control section 12a, a gas calorie control section 12b which sets the opening amount of the BFG flow control valve 11 based on the measurement results of the gas calorimeters 10a and 10b and sets the opening amount of the BFG flow control valve 11a based on the measurement results of the gas calorimeter 10c.

Being constructed as described hereinabove, in the gas calorie control section 12b, same as the second embodiment of the present invention, the feedback control is performed based on the gas calories of a mixed gas from EP4 that are measured with the gas calorimeter 10a, and at the same time, the feedforward control is performed based on the gas calories of the CFG's being discharged from the gas tank 2 that are measured with the gas calorimeter 10b. The feedback control being based on the gas calories of the CFG's that are measured with the gas calorimeter 10a and the feedforward control being based on the gas calories of the CFG's that are measured with the gas calorimeter 10b behave in the same manner as the feedback control and the feedforward control being performed by the gas calorie control section 12a of the second embodiment, thereby controlling the opening amount of the BFG control valve 11 so as to control the flow rate of the BFG being supplied to the gas mixer 3.

Additionally, in the gas calorie control section 12b, in addition to the behaviors of controlling the opening amount of the BFG control valve 11 by using the gas calorimeters 10a and 10b, feedforward control is performed in order to control the opening amount of the BFG control valve 11a based on the gas calories of the CFG's passing through the CFG inlet pipe 1a that are measured with the gas calorimeter 10c. Specifically, first, the gas calorimeter 10c measures the gas calories of the CFG's before being supplied to the gas mixer 3a from the CFG inlet pipe 1a. Then, based on the time for the CFG's to reach the gas mixer 3a from the gas calorimeter 10c that is estimated from the gas flow rate of the CFG's and on the gas calories of the CFG's that are measured with the gas calorimeter 10c, the gas calories of the CFG's to be supplied to the gas mixer 3a are confirmed beforehand.

As described hereinabove, are recognized the gas calories of the CFG's being supplied to the gas mixer 3a at the present moment when estimation is made by the feedforward control on the basis of the measurement values with the gas calorimeter 10c. Consequently, the opening amount of the BFG flow control valve 11a is determined based on the gas calories of the CFG's being supplied to the gas mixer 3a at the present moment of estimation so as to control the gas calories of the mixed gas being mixed with the BFG in the gas mixer 3a to be specific, and the flow rate of the BFG to the gas mixer 3a is determined. Then, the mixed gas being obtained by mixing the CFG's and the BFG in the gas mixer 3a is mixed with the BFG again in the gas mixer 3 after being mixed by time delay in the gas tank 2,

As described hereinabove, in the gas turbine system with the present embodiment, same as the second embodiment, first, the frequency and amplitude of the fluctuation constituents of the gas calories of a mixed gas being supplied to a gas compressor 5 are reduced by the gas tank 2, and at the same time the amplitudes of the low frequencies and the high frequencies of the gas calories of the mixed gas can be restrained by controlling performance based on the measurement values with the gas calorimeters 10a and 10b. Moreover, by performing a feedforward control on the basis of the measurement results with the gas calorimeter 10c for the gas mixer 3a being installed to the stage before the gas mixer 3, the fluctuation ratio of the gas calories of the mixed gas being supplied to the gas mixer 3 is mitigated, thereby further restraining the amplitude of the high frequencies overlapping the low frequencies of the gas calories of the mixed gas being supplied to the gas compressor 5.

Additionally, in each of the above-mentioned embodiments, a mixed gas serving as a fuel gas is generated by mixing the CFG's and the BFG. However, a mixed gas may be generated by mixing the BFG with COG so as to serve as a fuel gas. At this time, the flow rate of the COG is determined based on the gas calories of the mixed gas and the BFG. Moreover, in each of the above-mentioned embodiments, the gas tank 2 may be installed to a BFG supply pathway, and in each of the second and the third embodiments, the feedforward control may be performed based on the gas calories of either of the BFG and the COG, respectively.

In the description hereinabove, the gas calorie control equipment in accordance with the present invention is used for a gas turbine system. However, the present invention may be used not only for the gas turbine system but also for a boiler to which a blast furnace gas is supplied as a fuel gas.

What is claimed is:

1. A fuel gas calorie control equipment comprises:
a first gas mixer mixing a first fuel gas and a second fuel gas;
a first gas calorimeter measuring gas calories of mixed fuel gas being obtained by being mixed in the first gas mixer;
a feedback control section setting flow ratios of the first and the second fuel gases so as to control gas calories of the mixed fuel gas to be specific, based on measurement results of the first gas calorimeter; and
a gas tank providing the first fuel gas with different time delays and mixing and supplying the first fuel gas being provided with different time delays to the first gas mixer.

2. A fuel gas calorie control equipment as described in claim 1 further comprises:
a second gas mixer generating the first fuel gas by mixing a third fuel gas and the second fuel gas;
a second gas calorimeter measuring gas calories of the third fuel gas being supplied to the second gas mixer;
a first feedforward control section estimating gas calories of the first fuel gas being supplied to the gas mixer at present moment, based on gas calories of the third fuel gas being measured with the second gas calorimeter and setting flow ratios of the second and the third fuel gases to control gas calories of the mixed fuel gas to be specific.

3. A fuel gas calorie control equipment as described in claim 2 further comprises:
a third gas calorimeter measuring gas calories of the first fuel gas being supplied to the first gas mixer from the gas tank; and
a second feedforward control section estimating gas calories of the first fuel gas being supplied to the gas mixer at present moment, based on gas calories of the first fuel gas being measured with the third gas calorimeter and setting flow ratios of the first and the second fuel gases so as to control gas calories of the mixed gas to be specific.

4. A fuel gas calorie control equipment as described in claim 1 further comprises:
a third gas calorimeter measuring gas calories of the first fuel gas being supplied to the first gas mixer from the gas tank; and
a second feedforward control section estimating gas calories of the first fuel gas being supplied to the gas mixer at present moment, based on gas calories of the first fuel gas being measured with the third gas calorimeter and setting flow ratios of the first and the second fuel gases to control gas calories of the mixed fuel gas to be specific.

5. A fuel gas calorie control equipment as described in claim 1;
wherein, the gas tank comprises:
a chassis mixing the first fuel gas being supplied;
a piping for time delay being inserted from outside of the chassis to inside of the chassis, having the first fuel gas flow through inside thereof and having a plurality of nozzle holes formed on outer circumference thereof; and
a gas discharge pipe being installed to a portion excluding a portion where the piping for time delay is installed in the chassis and introducing the first fuel gas being mixed inside the chassis to outside of the chassis.

6. A fuel gas calorie control equipment as described in claim 5:
wherein, the gas tank has the piping for time delay consist of a main pipe being formed along inner wall of the chassis and a plurality of branch pipes being formed from the main pipe.

7. A fuel gas calorie control equipment as described in claim 6:
wherein, the gas tank has the chassis formed to be cylindrical;
has the main pipe formed so as to be along boundary line between upper end surface and side surface of the chassis and boundary line between lower end surface and side surface of the chassis and to connect portions being along boundary line between upper end surface and side surface of the chassis and boundary line of lower end surface and side surface of the chassis;
has a plurality of the branch pipes formed so as to be in parallel with outer circumference surface the chassis; and
has the gas discharge pipe inserted into inside of the chassis; and
has the gas outlet port provided in a center of end surface of the chassis.

8. A fuel gas calorie control equipment as described in claim 1:
wherein, the gas tank comprises:
a cylindrical chassis mixing the first fuel gas being supplied;
a gas inlet pipe introducing the first fuel gas;
an inner cylinder being connected to one end surface of the chassis, separating interior of the chassis into two regions and having nozzle holes connecting the two regions provided to inner circumference thereof; and
a gas discharge piping introducing the first fuel gas being mixed inside the chassis to outside of the chassis.

9. A fuel gas calorie control equipment as described in claim 8:
wherein, inner circumference surface of the inner cylinder is tapered toward proximity of other end surface of the chassis.

10. A fuel gas calorie control equipment as described in claim 1:
wherein, the gas tank comprises:
a chassis mixing the first fuel gas being supplied;
a gas inlet pipe being inserted into the chassis and introducing the first fuel gas;
nozzles being provided to edge of the gas inlet pipe;
a gas discharge piping introducing the first fuel gas being mixed inside the chassis to outside of the chassis; and
a gas outlet port where the gas discharge piping and the chassis are connected:
wherein, direction of the nozzles faces to be away from the gas outlet port.

11. A fuel gas calorie control equipment as described in claim 10:
wherein, direction of the nozzles faces to central axis of the chassis.

12. A fuel gas calorie control equipment as described in claim 10:
wherein, direction of the nozzles faces to be along circumferential direction of side surface of the chassis.

13. A fuel gas calorie control equipment as described in claim 10:
wherein, the nozzles and the gas outlet port are provided to lower end surface of the chassis; and
the nozzles have elevation angles with respect to lower end surface of the chassis and inject the first fuel gas to upper end surface of the chassis.

14. A fuel gas calorie control equipment as described in claim 13:
wherein, direction of the nozzles faces to central axis of the chassis.

15. A fuel gas calorie control equipment as described in claim 13:
wherein, direction of the nozzles faces to be along circumferential direction of side surface of the chassis.

16. A fuel gas calorie control equipment as described in claim 10:
wherein, a blocking plate blocking flow of the first fuel gas flowing into the gas outlet port is installed in neighborhood of the gas outlet port.

17. A fuel gas calorie control equipment as described in claim 10:
wherein, the gas inlet pipe is inserted from a plurality of positions of the chassis and provided with a plurality of the nozzles.

18. A fuel gas calorie control equipment as described in claim 17:
wherein, a plurality of the gas outlet ports are provided.

19. A fuel gas calorie control equipment as described in claim 1:
wherein, the gas tank is provided with a plurality of fans diffusing the first fuel gas inside the chassis.

20. A gas turbine system comprises:
a gas compressor compressing fuel gas;
an air compressor compressing air;
a combustor refining fuel gas by having the fuel gas from the gas compressor and the air from the air compressor supplied and burning;
a gas turbine being rotated and driven by combustion gas from the combustor; and
a fuel gas calorie control equipment as described in claim 1;
wherein, the mixed fuel gas from the fuel gas calorie control equipment is supplied to the gas compressor as the fuel gas.
